(19) United States
(12) Patent Application Publication
(10) Pub. No.: US 2015/0101543 A1
(43) Pub. Date: Apr. 16, 2015

(54) PROTECTED PET FEED STATION

(71) Applicant: Automated Pet Care Product, Inc., Pontiac, MI (US)

(72) Inventors: Brad Baxter, Bloomfield Hills, MI (US); Jason Smith, West Bloomfield, MI (US)

(73) Assignee: Automated Pet Care Product, Inc., Pontiac, MI (US)

(21) Appl. No.: 14/052,843

(22) Filed: Oct. 14, 2013

(51) Int. Cl. A01K 5/01

(52) U.S. Cl. CPC A01K 5/0142
USPC 119/498

(57) ABSTRACT

The present invention relates to articles comprising pet feeding enclosures adapted to protect the feeding animals from other pets. The present invention also relates to kits adapted to assemble such enclosures.

### FIELD OF THE INVENTION

The present invention relates to articles comprising pet feeding enclosures adapted to protect the feeding animals from other pets. The present invention also relates to kits adapted to assemble such enclosures.

### BACKGROUND OF THE INVENTION

Where two pets live in the same space one pet can interfere with the other pet while the second pet is attempting to feed. There are a number of solutions to this problem known in the art. One elegant solution is disclosed in Pfingsten et al. US 2010/0139570, incorporated herein by reference in its entirety, which discloses a pet feeder for feeding pets that provides an enclosure that the pet accesses through an entryway having dimensions under the control of the pet owner. The owner sizes the entryway to exclude a pet while allowing a relatively smaller pet to enter. Such system achieves the desired result. This system presents a problem when the pet to be excluded is smaller, or the same size as the exclusion without human intervention does not function as desired. This system can be quite large and presents some challenge with respect to efficient packaging and transport of the system. In addition, the system works where the pet to be excluded is larger than the pet which is meant to use the system. Where the pet to be excluded is a smaller pet, or a pet of the same size, the system does not achieve the desired result. In such instances intervention of a pet owner to adjust the opening to protect and isolate the larger, or same size, pet in the system is required.

Thus, what is needed is a pet feeding enclosure that can be operated without direct pet owner involvement and which can be packaged and transported in an efficient manner.

### SUMMARY OF THE INVENTION

The present invention relates to a kit comprising: a) a base which forms a continuous bottom having a first side adapted to face a supporting surface and a second side facing away from the supporting surface, wherein the base forms a location to hold one or more bowls and has connection points for two or more curved panels; b) two or more curved panels each having a bottom edge which is adapted to be connected to the base, two side edges which are adapted to be aligned to adjacent curved panels and a top edge, wherein when the two or more curved panels are adapted to be connected to the base and to adjacent panels to form a domed structure with the top edges of the panels forming an opening at the top of the dome opposite the base; wherein a first panel contains an opening large enough to allow a pet to pass through the opening which is adjacent to the bottom edge of the panel and the first panel has a door along the inside surface of the panel which can close or partially close the opening; a second panel contains a second opening large enough to allow a pet to pass through the opening which is adjacent to the bottom edge of the panel which is covered by one way door that is adapted to allow a pet to exit through the door by pushing on it; and the panels in the unassembled state nest within one another and can be disposed on the base to form a relatively flat profile which can be placed in a relatively flat container for transport.

The invention relates to articles comprising: a) a base which forms a continuous bottom having a first side adapted to face a supporting surface and a second side facing away from the supporting surface, wherein the base forms a location to hold one or more bowls and has connection points for two or more curved panels; b) two or more curved panels each having a bottom edge which is connected to the base, two side edges which are aligned to and connected to adjacent curved panels and a top edge, wherein the two or more curved panels form a domed structure with the top edges of the panels forming an opening at the top of the dome opposite the base; wherein a first panel contains an opening large enough to allow a pet to pass through the opening which is adjacent to the bottom edge of the panel and the panel has a door along the inside surface of the panel which can close or partially close the opening; a second panel having a second opening large enough to allow a pet to pass through the opening which is adjacent to the bottom edge of the panel which is covered by a one way door that is adapted to allow a pet to exit through the door by pushing on it.

In some preferred embodiments, the kits and assembly of the invention further comprise an entryway mat attached to or adapted to be attached to the base and disposed in front of the entry door which has a first surface adapted to face a support surface and an opposing second surface facing away from the support surface. In some preferred embodiments the entryway mat contains a sensor to detect a signal from a device disposed on a pet. In some preferred embodiments, the kits and/or articles further comprises a programmable controller in electronic communication with the sensor, a drive system in electronic communication with the programmable controller and further mechanically connected to the entry door, wherein the programmable controller based on the signal sensed by the sensor can activate the drive system to move the entryway door to an open, partially closed or closed position. In some preferred embodiments, the cover has one or more protrusions from a surface which cooperate with the top edge of one of the panels to hold it in place on the panel. In some preferred embodiments, the kit and assembled article of the invention have a slot formed about the periphery of the base which slot faces away from the supporting surface and the connection points for the curved panels are disposed in the slot in the base. Preferably the periphery of the base has a circular, elliptical or oval shape.

The articles of the invention can be manufactured in molds in a cost effective manner. The kits of the invention can be assembled to form the articles of the invention. The articles of the invention comprise enclosed dome-shaped feeding stations adapted to allow an authorized pet to feed inside the enclosure without interference from other unauthorized pets. In the embodiments wherein sensors are used to initiate opening or closing of the entryway door, the intervention of a human to open or close the entry door is not required. The dome shaped structure provides an ergonomic space for pet comfort, as it allows a pet to easily turnaround within the dome. The opening formed in the top of the dome provides for easy access to replenish food and water for pets. The assembled structure provides for containment of spilled water or food within the structure. The design of the components allows for transportation, shipping, of the kit in a relatively low or flat container. The kits and assembled articles of the invention allow for controlled access of pets regardless of relative size.

### DESCRIPTION OF THE DRAWINGS

FIG. 1 is an exploded view of a domed feeding enclosure.

FIG. 2 is a view of the kit in a configuration for shipping.

FIG. 3 is an assembled domed feeding enclosure with a cat entering.

FIG. 4 shows an assembled domed feeding enclosure with a cat exiting.

FIG. 5 is a view of an assembled dome from the top.

FIG. 6 shows the domed enclosure from the top with the cover hooked on a panel top edge.

FIG. 7 shows the assembled dome from the bottom of the base and the entryway mat.

FIG. 8 shows the bottom of the base with the motor cover removed.

FIG. 9 shows the bottom of the a domed enclosure with a second antenna.

FIG. 10 shows the second panel from the inside of the panel.

FIG. 11 shows an enclosure having a control keypad.

### DETAILED DESCRIPTION

The explanations and illustrations presented herein are intended to acquaint others skilled in the art with the invention, its principles, and its practical application. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The invention relates to a kit and the assembly based on the kit which forms a domed enclosure adapted to be utilized as a safe place for an authorized pet to feed without interference from unauthorized pets. The kit and assembly comprise a base that sits on a support surface which contains a specific location for placement of one or more food and/or water bowls. The base also provides the bottom of the enclosure and support for the panels that form the domed structure. The kit and assembly of the kit further comprises more than one curved panels which assemble to form the dome portion of the structure. One panel contains an opening and laterally sliding door utilized to provide entry access for an authorized pet. A second panel provides a second opening with a one way door disposed on the opening to allow the authorized pet to exit the domed enclosure. In preferred embodiments, the kit and assembly based on the kit comprises an entry mat which preferably houses a sensor that can recognize a signal from one or more pets. The sensor is connected to a programmable module which can be programmed to allow or deny access to the pet from which the signal is identified. The programmable module is connected to the entry door through a mechanical door control system such that the door can be opened or closed based on the program of the module. Authorized pet means a pet that is authorized to enter and feed in the enclosure. Unauthorized pet is a pet that is to be kept out of the enclosure. Support surface as used herein means the surface upon which the base of the structure is placed such as the ground, a building floor or a raised surface specifically adapted from holding the domed structure. One or more as used herein means that at least one, or more than one, of the recited components may be used as disclosed.

The kits and articles of the invention may further comprise any one or more of the features described in this specification in any combination, including the preferences and examples listed in this specification, and includes the following features: the base has a slot formed about the periphery of the base which slot faces away from the supporting surface and the connection points for the curved panels are disposed in the slot in the base; the periphery of the base has a circular, elliptical or oval shape; a cover for the opening in the top of the dome formed when the panels are assembled to the base and together, wherein the cover can be connected to the top edges of the panels, contains openings in the cover and the openings form a handle in the cover by which the assembled kit can be carried; an entryway mat adapted to be attached or attached to the base and disposed in front of the entry door which has a first surface adapted to face a support surface and an opposing second surface facing away from the support surface; the entryway mat contains a sensor to detect a signal from a device disposed on a pet; a programmable controller in electronic communication with the sensor, a drive system in electronic communication with the programmable controller and further mechanically connected to the entry door, wherein the programmable controller based on the signal sensed by the sensor can activate the drive system to move the entryway door to an open, partially closed or closed position; the cover has one or more protrusions from a surface which fit into one or more inwardly offset openings in the top edge of one of the panels to hold it in place on the panel edge; the cover has one or more hooks protruding from the bottom surface adapted to hold the cover on the edge of one of the panels when the cover is not located over the opening in the dome; the sensor and device on the pet are based on Radio Frequency, infrared, magnets, image recognition, and/or color recognition; the sensor and device on the pet are based on a Radio Frequency system; the panels are attached to the base and to one another using snap fit connections; the top edge of the panels have a flange having an inwardly offset opening in the flange and the cover contains one or more protrusions that fit into the openings of the flange on the top edge of the panel such that the one or more protrusions engage the openings of the flange to hold the cover in place on the flange and the handle in the cover can be utilized to pick up the article; the drive system comprises a motor in mechanical communication with a gear wherein the gear is in contact with the entryway door so that when the motor is engaged, the entryway door can be moved to a closed, partially closed, or open position; the drive system further comprises a low resistance clutch in mechanical communication with the gear such that when the motor is engaged to move the entryway door and the door engages mild resistance the door is prevented from moving in the desired direction as long as the resistance is present; the base further defines an integral shallow dam in front of the door opening; the article comprises three panels and the periphery of the base has a circular shape; three or more feet located on the first surface of the base adapted to support the article in a stable manner on a support surface; the second door is a one way hinged flip door, the sensor disposed on the entryway mat can sense the presence of a pet inside the enclosure having a signal device near the entry door and the controller is programmed to open the door when the presence of a pet inside the enclosure having a signal device near the entry door is sensed; a sensor is disposed near the inside of the entryway door to sense the presence of a pet inside the enclosure having a signal device near the entry door and the controller is programmed to open the door when the presence of a pet inside the enclosure having a signal device near the entry door is sensed; the base provides a location to hold two bowls; the base provides a location to hold two bowls; three or more feet located on the first side of the base adapted to support the article in a stable manner on a support surface; the cover contains two or more protrusions evenly spaced about the perimeter of the underside of the cover wherein the protrusions are shaped to hold the cover in place on a panel edge along the opening in the dome; the entry door is curved to match the internal shape of the panel to which it is attached and is disposed offset from an inside surface of the panel and held in place at the bottom in the first slot of the base or in a separate door slot adapted for supporting and guiding the door and by a flange on the panel at the top of the panel; the gear is in contact with a gear rack attached on the inside of the entry door near the bottom; the programmable controller can be programmed to recognize more than one signal from more than one signal device; a sensor may also be placed on the first side of the base adapted to recognize the presence of a pet in the article and the programmable controller is programmed to move the entry door under certain conditions when the presence of a pet in the article is sensed; a sensor is placed in the base below the entryway or about the entryway door to sense the presence of a pet in the entryway; the sensor under the entryway may be a capacitance sensor; a light is located in the domed structure; wherein the light is connected to a light sensor such that the light is turned on when a low light level is detected; one of the panels has disposed on an outer surface a control panel adapted to control one or more functions of the article; and one of the panels has disposed on an outer surface a display panel adapted to display the status of one or more functions of the article.

The kit and articles of the invention comprise a base. The base serves as the bottom of the formed dome structure, supports and facilitates connection of the panels together, provides a location for one or more food and water bowls, serves as a floor for the domed structure and protects the surface of the support structure from damage due to spilled liquids or food. The base may optionally house one or more sensors, house a mechanical system for moving the entryway door, and connect to and locate the entryway mat. The base comprises a molded structure adapted to perform some or all of the recited functions. The base may be prepared from any material that can be molded to perform the recited functions. Preferably the material is of the base is a polymeric system. The polymeric system may be a thermoplastic or a thermoset material that can be molded to perform the recited functions. Preferred polymeric systems comprise polyolefins (polyethylene, polypropylene, polyalkadienes), styrenics, acrylates, acrylonitriles, polycarbonates, polyurethanes, polyamides, polyesters, copolymers and blends thereof. Particularly preferred materials comprise polyolefins, styrenics, polycarbonates, acrylonitrile butadiene styrene (ABS) and blends thereof. Such materials may be modified with a number of additives such as fillers, elastomers, fire retardants, stabilizers and the like. The base may be prepared known processes capable of forming the base in a manner to allow it to perform the recited function, such as injection molding, reaction injection molding, thermoforming and the like. The base is preferably a single molded component to facilitate it functioning as a barrier to protect the support surface from damage due to contact with spilled food or liquids from the food and/or water bowls.

The base provides a location for one or more bowls. The bowls are used to hold food and water (or some other liquid that may be used for a pet). By providing a location for one or more bowls means that the base in some way secures the bowl or bowls in a location such that if the domed enclosure is moved the bowls stay in the designated location. The bowls may be located by securing them in place with one or more mechanical fasteners or by forming one or more bowl locations in the molded base. Preferably the molded base forms one or more pockets adapted to hold one or more bowls. Such pockets are preferably molded into the base. Preferably the base provides two locations for two bowls, and preferably provides two molded pockets for bowls. In essence the pockets are sized such that a pet bowl can be set in the pockets. The base preferably has a slot formed about the periphery of the base wherein the slot is open on the second surface (opposite the surface in contact with the support surface). The bottom of the entryway door can be located and/or secured in the slot. The slot can function to receive and support the bottom edge of the panels which form the dome. The first or second slot may also provide a space for the entryway door to slide laterally to allow it to open and close. A second slot may be formed in the base. The second slot may be utilized to house the bottom of the entryway door and to allow it to slide between the open, closed and partially closed positions. Preferably the slots are isolated from the open area of the base that is the second side of the base which forms a floor in the dome. The slots are isolated to prevent liquid, water, or food spilled in the dome from entering the slots. A dam between the floor portion of the dome and the entryway can achieve this objective. The base provides a raised area around the periphery of the base inside the panel connection points and/or the slot in the base. The raised area preferably is not located between the center of the base, where the floor is located, and the entry way door to facilitate access of a pet to the center of the floor of the dome. The shallow dam and the raised area about the periphery can cooperate to retain spilled liquids and food in the dome. The base may form a flange to hold the entryway door in place and to allow it to move laterally to open and close.

The base provides connection points for the bottom of the curved panels so as to support and secure the panels at the bottom. The connection points are near the outside periphery of the base. In some embodiments, the bottom edge of each of the panels is secured in connection points in the first slot. The bottom edge of the panels are secured to connection points in the base by one or more fasteners or by integrated snap fit fasteners. Any fastener that is capable of securing the bottom edge of the panels may be utilized, exemplary fasteners include screws, embedded screw receivers, nuts, rivets, brads, nails, snap fit connectors and the like. Snap fit connectors comprise generally a protrusion on one part and a opening in a second part that receives the protrusion. The protrusions generally contain a lip that once the protrusion passes through the opening in the second part the lip engages the opposing side of the opening to prevent undesired release of the protrusion from the opening. The protrusion and opening can be disposed on either of the two parts. In one embodiment the fastener can be a protrusion that fits into a boss in the other part. A snap fit can be secured in place using another fastener, secondary fastener, such as a screw, brad, rivet, cotter pin and the like. In one preferred embodiment the secondary fastener is a self-tapping screw. The number of fastening points is chosen to result in a secure structure. The slot may also provide a space for the entryway door to slide laterally to allow it to open and close. The base may form a flange to hold the entryway door in place and to allow it to move laterally to open and close.

The base may house a mechanical system to move the door as directed by the programmable module. The base may provide a housing for one or more sensors as described hereinafter. Where utilized the entryway mat may be connected to the base. The connection may be made using any connection system such as those discussed hereinbefore with respect to the base and the panels. The base may have inserted in or molded in reinforcement structures adapted to support the surface of the second surface, the surface in the domed structure, such as posts, or ribs in a pattern which contact the support surface so as to stabilize the structure and the floor of the domed structure. The base may comprise three or more structures that contact the support surface and support the entire structure, such structures may be feet that contact the support structure. These structures may be mechanically affixed to the base or may be molded into the base. These structures, feet, preferably have rubber bottoms to protect the support surface on which the domed enclosure is placed from scratching and marring. Preferably the base contains three or four of these structures, feet, and more preferably four. The base in the plane perpendicular to a support surface has a shape, the periphery has a shape, that allows formation of a domed structure. Such shape can be irregular, polygonal (rectangular, square, pentagonal, hexagonal, octagonal and the like), circular, oval, elliptical and the like. Preferably the shape is circular, oval, elliptical and the like, and most preferably circular.

The kit and assembled articles of the invention comprise two or more panels. The panels connect with the base and one another to form a domed enclosure which is secure and stable. The panels form an oval, elliptical or circular (preferably circular) opening at the top of the domed enclosure. In the unassembled state the panels can be nested together and placed on the base such that the parts form a reasonably low profile and can be packaged in a relatively flat container for efficient shipping and storage. The panels house the entryway, exit doors, peripheral components such as lights, light sensors, display panels, manual control panels, door control devices, and the like. The panels further facilitate holding in place a cover for the opening in the top of the dome structure.

The panels are preferably molded and can be prepared from any of the materials useful to prepare the base using the known processed for molding parts for such materials including those disclosed hereinbefore. The panels comprise generally four edges, a bottom edge adapted to contact and connect to the base, two side edges adapted to contact and connect to adjacent panels and a top edge which in conjunction with all of the panels form an opening at the top of the domed enclosure. The top edge is preferably adapted to secure a cover over the opening in the top of the dome. The panels have a curved profile from the bottom edge to the top edge and a curved profile from side edge to side edge. The shape of each panel is similar to a trapezoidal shape and is chosen such that when the panels are assembled on the base a domed enclosure with an opening at the top is formed. The domed enclosure is completely enclosed except for the opening at the top, the two door openings and where used door handle openings. The panels may form other small openings for a variety of purposes but such openings must be small enough to exclude an unauthorized pet. The panels are sufficiently thick enough to provide a sturdy protective structure for an authorized pet feeding within the structure. As a result the thickness is chosen such that an unauthorized pet cannot break through the panel walls or cause the assembled structure to disassemble. The panels fasten to the base and to one another using any fasteners that facilitate the assembly of a sturdy structure. Such fasteners are discussed hereinbefore. Preferably the fasteners are integrated fasteners and snap fit fasteners. Preferably at least two fasteners are used along each edge of each panel in contact with the base. Preferably the adjacent panels are connected to one another along or near the intersection of the top edge and side edges. The side edges of the panels may have alignment features along the sides to align the panels together along the adjacent side edges. Such alignment structures include ridges, slots, and the like. The domed structures of the invention comprise two or more panels, preferably three or more panels, even more preferably three or four panels and most preferably three panels.

Preferably the top edge of each panel forms a flange adapted to secure a cover over the opening at the top of the domed structure. Preferably the flange contains one or more openings adapted to allow protrusions from a cover to pass there-through so as to allow the cover to be secured to the top of the domed structure. Preferably the openings are inwardly offset. One panel, a first panel, has an opening for the entryway which is adapted to allow an authorized pet to enter and optionally exit the domed enclosure. The opening preferably opens along the bottom edge of the panel. The opening is of sufficient size to allow a pet to pass through the opening. Preferably the base forms one side of the opening. Preferably this panel has disposed above the opening for the entryway a slot or flange to secure the entry door to the panel and allow the entry door to slide laterally to open and close the door. In the kit form the door preferably is attached to the panel. In the kit form the door can be separate from the first panel. Preferably, the door is vertically sandwiched between an integral flange and ribbed bearing surface of the panel at the top and an integral and curved receiving slot in the base, that is the first or second slot as described hereinbefore. The entryway door is disposed parallel to and offset from the panel. It is adapted to slide laterally from side to side along the entryway opening. In essence, the door has a similar curvature as the panel to which it is attached and the door slides laterally along a curved path as defined by the panel and a slot in the base in a parallel path to the panel. Preferably the door is a molded structure of material similar to or the same as used for the panels and/or the base. The door may be moved to open, partially close or close the door manually or using an automated drive system. In the embodiment wherein the door is opened manually the door may have a handle attached to the door. In a preferred embodiment the door has a handle attached to one side wherein the handle protrudes from a separate opening in the panel. The opening is preferably shaped to allow moving the door laterally from an opened to a partially closed position. The opening is preferably a slot wide enough to allow the door to be moved from fully open to fully closed. In one preferred embodiment a plurality of stops are included in the slot to allow the door to be secured in a plurality of positions from fully open to completely closed. Alternatively the door has a gear rack connected to thereto or molded therein which when the domed structure is in contact with a gear attached to a motor so as to move the door laterally. Preferably the door is connected to an automated system to move the door. The gear rack is preferably attached to the inside of the door at or near the bottom of the door.

A second panel has an opening adapted for the pet to exit from the domed enclosure in a different location that the entryway door. The opening preferably opens along the bottom edge of the panel. The opening is of sufficient size to allow a pet to pass through the opening. Preferably the base forms one side of the opening. Preferably the panel with the exit opening has a one way door attached to the panel such that the door covers the exit opening. The exit door is of sufficient size to cover the exit opening. A one way door in this context is a door that opens from the inside by pressure applied by the pet but cannot open as a result of pressure applied on the outside of the panel. Preferably the door opens out from the panel and closes once the pet has cleared the opening and the door. Preferably the door is mounted to the panel using a spring. Preferably the door is a molded structure of material similar to or the same as used for the panels and the base. Preferably the door at its bottom abuts the base so that the base prevents it from being pushed inward. The opening in the top of the dome provides access to the interior of the dome and facilitates inserting into and removing from the enclosure bowls with food and water.

The kit and assembled structure of the invention may further include a cover to be placed over the opening at the top of the domed structure. The cover functions to prevent access of an unauthorized pet through the opening at the top of the domed structure while allowing incident light to enter the enclosure and air flow into or out of the enclosure. Preferably the cover is securable to the top edge of the panels. Preferably the cover contains one or more openings to allow light to enter the enclosure and air flow in and out of the enclosure. Preferably the cover forms a handle that allows the enclosure to be moved when the cover is secured to the top edge of the panels. The shape of the cover is preferably generally oval, elliptical or circular, and preferably circular, in shape and of the same shape as the opening in the top of the dome. The openings in the cover form a handle which can be used to carry the domed structure when the cover is secured into the opening. The cover contains one or more, preferably two or more, protrusions on its bottom surface. The protrusions have sufficient structure to cooperate with the edges of the curved panels forming the opening in the dome to secure the cover in the opening and to allow the integral handle in the cover to support the structure when it is picked up and carried by the handle. Bottom surface as used with respect to the cover means the surface that faces into the dome when attached to the dome. Preferably such protrusions are adapted to fit into inwardly offset openings in the flanges at the top edges of the panels in a manner such that the protrusions secure the cover to the panel edges. Preferably such protrusions fit within the opening without significant deflection when the cover is placed into the opening with the protrusions not aligned with openings in the flanges and allow the cover to be rotated in the opening until the protrusions align with the inwardly offset openings and seat therein to secure the cover in the opening. The protrusions preferably have sufficient elasticity such that the cover can be repeatedly removed from the opening and placed in the opening. In a preferred embodiment, the panels and the cover have markings on the outside to indicate where the protrusions on the cover are located and wherein the inwardly offset openings in the panel flanges are located to allow easy alignment thereof to facilitate securing the cover in the opening. Preferably the cover has two or more protrusions. Preferably the cover has a protrusion to be aligned with a flange in each panel. Preferably there are three or more protrusions, even more preferably three or four protrusions and most preferably three protrusions. Preferably the cover comprises a molded material prepared as described hereinbefore.

The cover further comprises one or more hook like structures that protrude from the bottom of the cover. Such hook like structures are adapted to hold the cover on the opening at the top of the dome when the cover is not located in the opening. To access the domed structure the cover needs to be removed. When removed the cover can be hooked on the opening to insure it is available when needed. In a preferred embodiment the cover has the same number of hooks as protrusions for securing the cover in the opening. Preferably the hooks are disposed inboard from the protrusions.

The entryway door is adapted to open and close to permit and prevent access to the domed structure. The entryway door is disposed inside of the first panel in a manner such that it can open, partially close and close the door. The door is curved so as to move parallel to the first panel. The door moves laterally along the inside of the first panel generally in a curved path. Where the door is opened and closed manually the door has a handle attached. Preferably the handle protrudes through another opening in the first panel to allow the door to be moved. Preferably the opening is a slotted opening to allow the handle to be moved in a direction parallel to the plane of the base. The slot may have a plurality of stops adapted to hold the door at various locations from completely open to completely closed. This allows the door to be partially closed to allow access of a smaller pet and prevent access to a larger pet. The handle may include a locking feature to lock the door in a chosen location. Where the door is moved using an automatic system, the door may contain any appropriate features to connect the door with a mechanical system to move the door, for example a gear rack, pulleys, cables, friction drive, and the like. Preferably the door contains a rack to work with a gear attached to a mechanical system. The gear rack can be attached to the door or can be molded into the door. Preferably the gear rack is located on the inside of the door near or at the bottom of the door. The door is of sufficient size to cover or partially the entry way opening when closed or partially closed. The door is of sufficient thickness and strength to prevent an unauthorized pet from forcing their way into the domed enclosure. The door preferably comprises a molded material prepared as described hereinbefore. The door may be held in place by any system that allows the door to move laterally as described herein and that allows the door to be secure if an unauthorized pet tries to force its way into the enclosure. The door is preferably supported and held in place by slots or flanges in the panel and optionally by a slot in the base.

The second panel contains a second door. This door is adapted to provide an exit point from the dome remote from the entryway door. This door may be the only exit point or an alternate exit point. The door is of sufficient size to cover the exit opening and strength to prevent an unauthorized pet from forcing their way into the domed enclosure. Preferably the door is attached to the second panel with a structure that allows the pet to push it open from the inside but prevents the door from swinging inside the domed enclosure. The door is preferably large enough to abut the base so as to prevent it from being pushed into the domed structure. The door may be connected to the panel at any location and in any manner that allows it to perform the desired function. Preferably the door is connected to the panel above the exit opening. Preferably the door is hinged to retain the door in place and to facilitate closing once the pet has cleared the exit opening. Preferably the door is connected to a structure that closes the door once the pet clears the exit opening, such as a spring, hydraulic arm, and the like.

The kit and assembled article may provide a locking mechanism on the entry door to prevent an unauthorized pet from forcing the door open. The locking mechanism can be set to automatically lock when the door is closed or partially closed. If the door is a manual door a pet owner would need to release the lock to open the door. If the door is opened automatically the locking mechanism can be opened as part of the door opening sequence. Any locking mechanism that secures the door may be utilized for example a pin that engages the base or entry opening, and the like. In one preferable embodiment the door may be set to only close partially, leaving a small gap between the door and one side of the entryway. This prevents a pet's limb or tall from being pinched in the closed door.

The kit and assembled article of the invention further comprises an entryway mat. In the kit, the mat can be a separate component or attached to the base. In one embodiment the mat can be folded under the base and connected to the base. In assembled form the entryway mat is attached to the base in front of the entry way. The entryway mat has two sides, a bottom side adapted to be placed on a support surface and a second side which is the top side facing upward opposing the support surface. The top side is adapted to provide a surface for a pet to step on before entering the domed structure. The entryway mat protects the support surface in front of the domed structure, where “in front” refers to the portion of the domed structure in the vicinity of the entryway door. The entryway mat is of sufficient size and strength to protect the surface in front of the entryway opening. The entryway mat may also function to house other functional components, including sensors adapted to sense the presence of a signal related to a pet, programmable controllers, parts of a mechanical system to open the entryway door, and the like. The entryway mat may be prepared from moldable materials described hereinbefore in the manner described hereinbefore. In a preferred embodiment the entry way mat comprises two parts a bottom part comprising the bottom side and a top part comprising the top surface. The two parts can be assembled to form the entryway mat. Preferably functional components are located on the bottom side of the entryway mat or between two parts of a mat, the bottom part and the top part. Preferably the bottom side of the mat contains structures to contact the supporting surface and to provide space for the functional components between the support surface and top side of the entryway mat, for instance ribs, standoffs, protrusions, and the like. The functional components of the entryway mat for instance sensors or programmable controllers may be located between the two parts. The two parts may be assembled using known connector systems or snap fits.

The kits and assembled articles of the invention may further comprise one or more sensors adapted to recognize the presence of one or more signals associated with one or more pets. Signals from the sensors can be utilized to authorize access to the dome, deny access to the dome, prevent the entryway door from closing on a pet, allow only one pet in the dome at one time, open the entryway door to allow a pet to leave the enclosure, and the like. One type of sensor recognizes a signal from a device attached to or implanted into a pet. Thus a pet can be equipped with a device to reflect or generate a signal. The device that reflects or generates the signal can reflect or generate a radio frequency signal, an infrared signal, and the like. The sensor can read such signals, sense the weight of the pet, sense the presence of the pet at a certain location, recognize the image of the pet or a color of a tag worn by the pet, or the like. A sensor may be located in the entryway mat to sense the presence of a pet near the door. Preferably the sensor reads an infrared signal, a radio frequency signal, determines the weight of the pet, the image of the pet or a color associated with the pet. Preferably the sensor senses radio frequency signals. A proximity sensor may also be placed about the entry way opening, in the base and or around the opening, to sense the presence of a pet in the entryway opening, preferably to prevent the door from closing on the pet. If the door closes on the pet, the pet may be injured or may shy away from using the enclosure. Preferably such proximity sensor is a weight sensor or a capacitance sensor. A sensor may be located in the base so as to sense the presence of the pet in the domed structure. Such sensor can be any of those disclosed hereinbefore. The sensed presence of the pet in the domed structure may be utilized to cause the entry way door to close automatically. The sensor on the entryway mat may be of sufficient strength to recognize the presence of the pet signaling device near the entryway door within the dome so as to initiate opening of the entryway door. Alternatively a sensor may be located in the base within or at the edge of the dome near the entryway to sense the presence of the pet near the entryway door to trigger opening of the entry way door.

The kit or assembled article of the invention may contain a programmable controller. The programmable controller receives information from the sensors and can be programmed to respond to the signals. Such responses can be to open or close the entryway door, stop the door from closing on a pet in the entryway, authorize access of a pet to the domed structure, prevent access of an unauthorized pet to the domed structure, prevent the entryway door from opening when an unauthorized pet is too close to the entryway door, turn on or off lights in the domed structure, indicate the presence of a pet in the domed structure, respond to signals from multiple pets, and the like. The programmable controllers can be preprogrammed at a factory or can allow partial or full programming by the ultimate user. The programmable controller is linked to one or more sensors located on the articles of the invention. The programmable controller may be located in the entryway mat or in the base. The ridges in the base provide a convenient location for the controller. The programmable controller can be linked to a mechanical system adapted to open and close the entryway door, lights, displays, control panels on the device, and the like. Based on information received from sensors on the article, the controller can operate any of the functional components. The controller can initiate opening or closing of the door according to the programmed logic of the system.

The kits and articles of the invention may comprise a mechanical system for opening the entryway door. Any known mechanical system for moving the door may be used. Exemplary systems include a motor attached to one or more systems that can be driven to open the door, for example a chain and gears and gears and gear racks. In a preferred embodiment the mechanical system comprises a motor attached to a gear which is further attached to a gear rack on the entryway door. Preferably the mechanical system contains a feature such that if the door experiences resistance, for example if a pet is in the door way, the door stops moving or returns to an open position. Examples of such features are low torque clutches, and the like. Preferably such a clutch is located between the motor and gear. Any motor which performs the desired function may be used, for example a direct current driven motor or an alternating current motor, or a stepper motor. The motor may be powered by a battery or an alternating current through a transformer, and the like.

The kits and articles of the invention may further comprise one or more lights disposed in the dome or near the entryway to provide light for the pet. Any light which provides adequate light may be used, for instance LED lights. The lights may be manually operated or can be tied to a light sensor in the dome or near the entryway wherein if the ambient light is too low the lights can be turned on automatically. The kits and assembled articles of the invention may include indicator panels disposed on the base or one of the panels that display information about the system, for example status of lights, presence of pets in the dome, pets authorized for access, battery level, food and water levels, status of door opening, and the like. The base or panel may include a panel with programming or function buttons for adjusting operation for the device. Such panel can be used to operate the door, operate lights, program the programmable controller. The panel can contain an interface for programming the controller for instance a USB port, micro USB port, a wireless module adaptable to communicate with a wireless network to provide a user the ability to program the controller via a wireless computer connection. The kits and assemblies can contain one or more devices that send or reflect signals to the sensors described herein. Extra signal devices may be available with the kit or as replacements.

The kit of the invention can be assembled to form the domed structure of the invention. The kit is adapted to be shipped in a relatively flat profile to a consumer or to a retail establishment. Preferably the panels are nested into one another and placed on the base with the outside surface of the outside panel disposed on the base. Any other peripheral parts can be placed on the panels. The kit can then be placed in a relatively flat shipping container or box.

The kit is assembled by placing the base on a flat surface. If an entryway mat is present it is either folded out to be located in front of the entry opening location or it is attached to the base. Any fasteners or locks to retain the entryway mat in place are engaged. This is preferably done prior to placing the base on the flat surface. The edge of the panels are aligned using any alignment features. Preferably the panels are connected together near the top of the panels. In a preferred embodiment each panel has a screw boss that fits into a screw boss pocket in the adjacent panel. In a more preferred embodiment a self-tapping screw is inserted through an opening in the screw boss pocket and threaded into the screw boss to provide additional strength and integrity of the cover opening. After all of the panels are assembled together to form the dome, the bottom edge of each panel is connected to the base. If standard fasteners are utilized the fasteners are fastened according to standard procedures. If a snap fit connection is used, the base and the bottom edge of the panels are snapped together. The cover is then inserted such that the protrusions seat in the inwardly offset openings to secure it in place. If the unit requires programming or allows programming it can be programmed according to the logic of the system. The cover can be removed and optionally placed on a panel edge when not located in the opening. With the cover removed food and water bowls may be removed and filed and/or replaced.

The programmable module can be programmed with logic based on a pet owners need. For example the module can be programmed to open the door when the signal from an authorized pet is received. It can be programmed to keep the door closed when the signal from an unauthorized pet is received. The system can be programmed, such that when the door is opened automatically, to close the door after a certain time period, for instance 5 to 10 seconds. The delay is to allow time for the pet to enter. The system can be programmed to open if resistance to the door closing is present, indicating the pet is in the entryway. Alternatively a clutch can be used to stop door movement when resistance is received. Alternatively an additional sensor can be placed in the base to sense the presence of a pet and the system can be programmed to close the door when the pet is sensed to be in the enclosure. The pet can exit by pushing through the exit door or the system can be programmed to sense the pet by the entry door to open the entry door. Alternatively the entry opening can have sensors to sense the presence of the pet in the entry way and the system can be programmed to keep the door open in such an instance. For example, capacitance sensing may be used around the perimeter of the sliding door entry to detect the presence of a body. The sliding entry door can have two small magnets installed at the bottom of the door. One magnet on the leading edge of the door will be North facing down and another magnet located at the trailing edge of the door will be South facing down (or vice versa). Located under the base and corresponding to the same location of the leading edge magnet in the open position and the trailing edge magnet in the closed position (this allows positioning the sensors in a single area), there will be two uni-polar Hall effect sensors placed in close proximity to one another (within the sensing range of a single magnet) with the active sensing surface of one sensor pointing up and the other pointing down. In this setup, assuming a South pole activating sensor, the leading edge magnet with North pole facing down will only be detected by the down facing Hall effect sensor (active sensing surface pointing away from magnet), and the trailing edge magnet with South pole facing down will only be detected by the upward facing Hall effect sensor (active sensing surface pointing toward the magnet). In this way it is always known if the door is open, closed or in between positions.

An exemplary operating scheme may be used as described hereinafter. As an authorized pet having an RFID tag approaches the domed enclosure and the RFID tag passes over the antenna located in the mat as described above, the sliding entry door will start to open. Once the door reaches the open position and the RFID tag is no longer detected by the antenna in the mat, a timer will start and after 5 seconds, the door will close. The time for the door to open or close is approximately 3 seconds. If for some reason the door does not reach the open or closed position within a timeout value of 5 seconds, the door will attempt to return to its original position from where it started, and after pausing for 2 seconds at the original position, the door will attempt to open or close again for a total of 3 attempts. If after 3 attempts, the door does not reach its intended position, the door will attempt to open for 5 seconds (timeout value) and then the motor will stop and a fault indicator LED will flash once per second. When the pet is ready to leave the enclosure, it may leave through the one-way flip door, or it may attempt to leave through the sliding entry door. The antenna in the mat may extend slightly under the base of the unit and allow the pet's RFID tag to be detected if the pet's head is close to the interior surface of the sliding entry door. After the door opens, the pet leaves, and the RFID tag is no longer detected by the mat, a timer will start (as described above) and after 5 seconds the door will shut. If however during this 5 second period an unauthorized RFID tag address (2nd tag required) is detected on the mat, the door will attempt to close immediately. If an authorized and unauthorized RFID tag address are detected by the mat at the same time (unauthorized on the mat first then authorized joins), the sliding entry door will not open, and if an authorized and unauthorized RFID tag address are detected on the mat at the same time while the door is opening and/or during the 5 second timer, the door will attempt to close Immediately. As mentioned above, the door can be driven through a light clutch and therefore will not injure a pet if the pet is within the doorway and the door attempts to shut (it will simply slip the clutch, timeout and return to the open position and then attempt to shut again after 2 seconds), however capacitance sensing may be used around the perimeter of the sliding door entry for detection of a body in the doorway. If a body is in the doorway the door will not shut until the body is clear of the entry opening.

### ILLUSTRATIVE EMBODIMENTS OF THE INVENTION

The following descriptions of the Figures are provided to Illustrate the invention, but are not intended to limit the scope thereof.

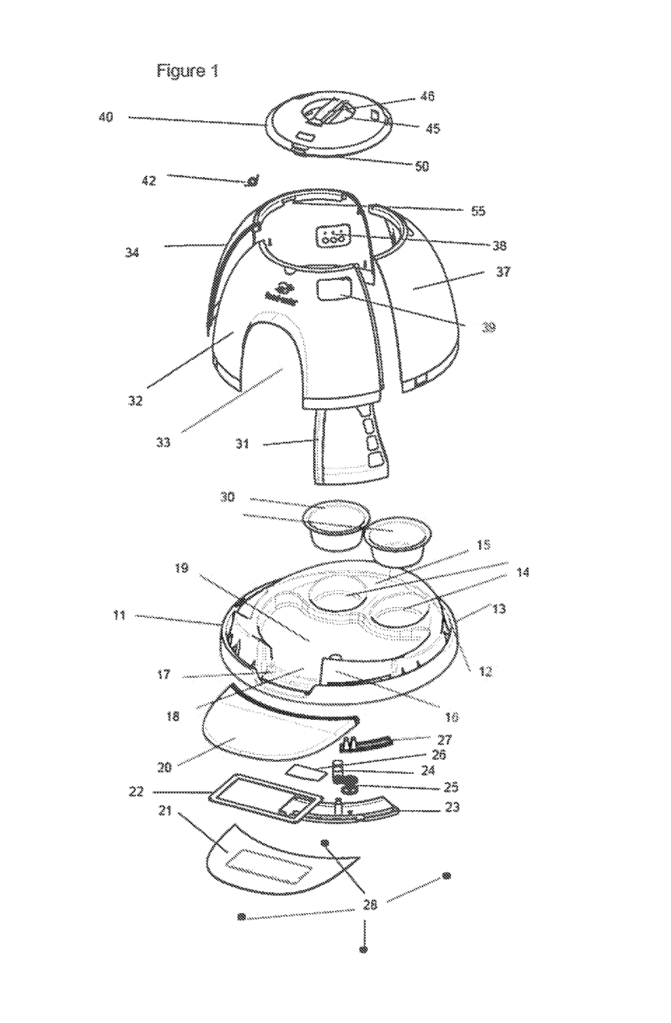

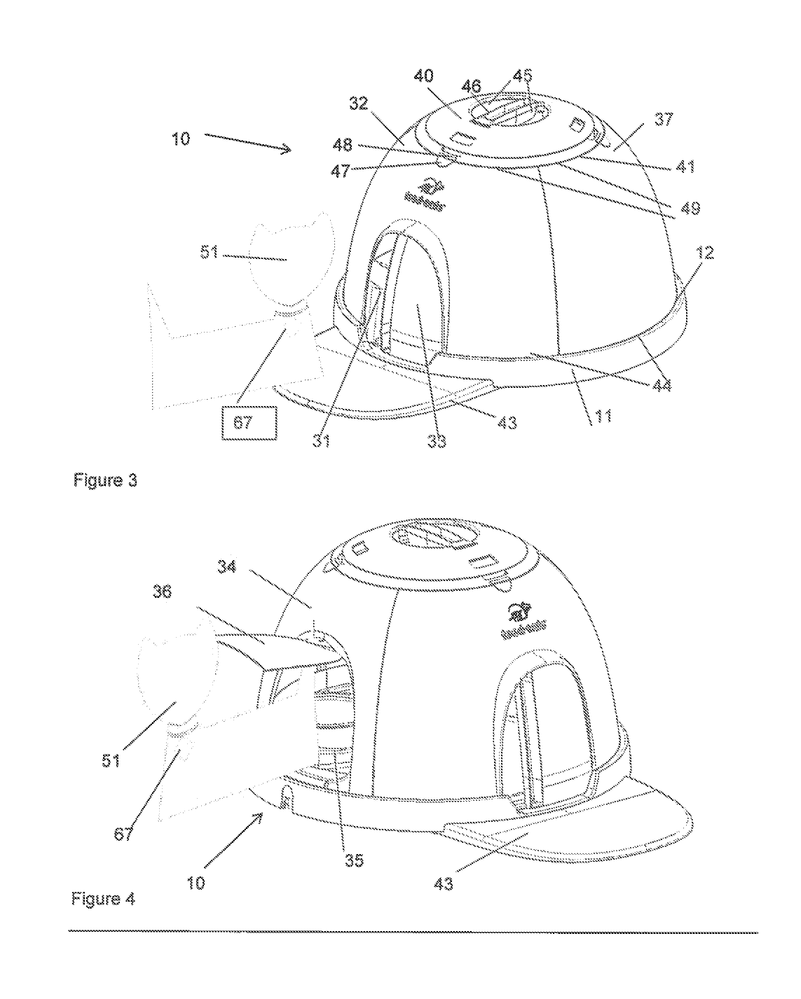

FIG. 1 is an exploded view of an article of the invention. FIG. 1 illustrates an exploded view of a domed pet feeding structure of the invention 10 which is shown in assembled form in FIG. 3. Shown is a base 11, having a slot 12 about the periphery of the base 13. The base 11 has two molded pockets 14 for bowls in a raised area which forms the pockets 15, a ridge 16 inboard of the slot 12, a shallow dam 17, in front of an opening 18 in the ridge 16 for the entry door. The center of the base forms a floor 19 for the structure. Shown is a top part of an entry mat 20 and a bottom part of the entry mat 21, an antenna for a sensor 22, a cover for the motor 23 and a motor 24, a clutch and drive gear 25, a programmable controller 26 and a gear rack 27. Shown are rubber feet 28 for the base 11. Two bowls 30 for placement in the bowl pockets 14 are shown. Shown is an entry door 31, a first panel 32 having an entry opening 33, a second panel 34 having a exit opening 35 adapted for use with an exit door 36 not shown. A third panel 37 without an opening is shown. A control keypad 38 adapted to be placed in a control keypad opening 39 in the first panel 32 is illustrated. Also shown is a cover 40 for the opening 41 in the top of the dome, opening 41 shown in FIG. 3. Also shown is a torsion spring 42 for spring loading an exit door 36.

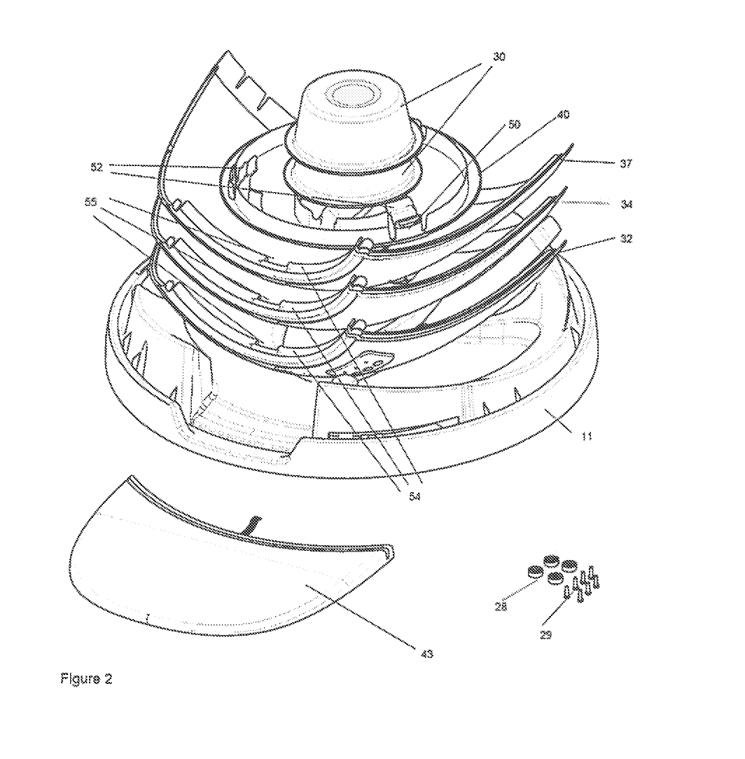

FIG. 2 is a kit of the invention arranged in a form for shipping. Shown is an assembled entry mat 43 separate from the base 11. A base 11 is located below the first panel 32, second panel 34 and third panel 37 wherein the panels are nested together. Disposed above the nested panels is the cover 40 and two bowls 30. Separate are screws 29 and rubber feet 28 which can be packed in a container and placed in a container for the kit.

FIG. 3 is an assembled domed feeding enclosure. Shown is a first panel 32, a third panel 37 assembled on a base 11. Disposed in front of the domed structure 10 is an assembled entryway mat 43. The entryway mat 43 is shown located in front of the entryway opening 33. The entryway door 31 is shown partially opened. The panels 32 and 34 are shown having their bottom edge 44 disposed in the slot 12. Shown is a cover 40 having two openings 45 which form a handle in the cover 46. Also shown are markings on the panel 47 and markings on the cover 48 adapted to be aligned to show where the cover 40 is seated in the panel top edges 49 forming the dome opening 41. Top panel edges 49 are shown in FIG. 6. Also shown is a rendering of a cat 51 wearing a signaling device 67 entering the domed feeding enclosure 10. Shown are rubber feet 28 for the base 11 and screws 29 for assembly.

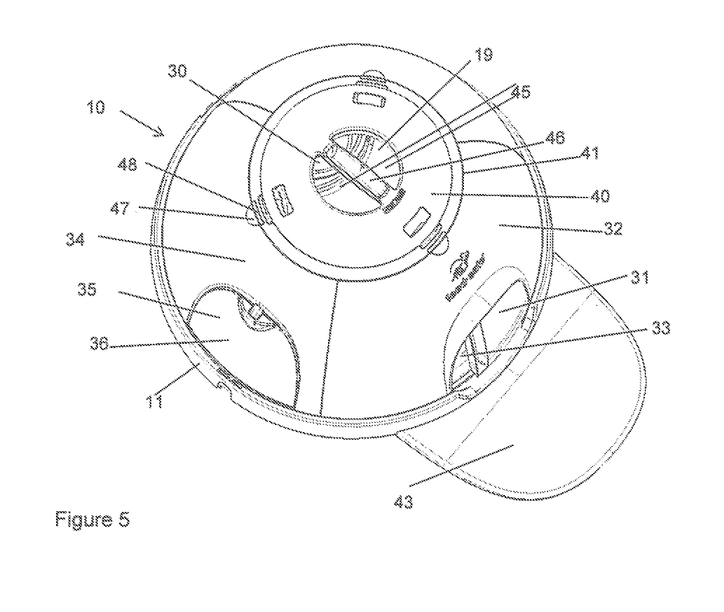

FIG. 4 shows an assembled domed feeding enclosure with a cat exiting. Shown in the domed structure 10 as assembled. Shown is the exit opening 35 in the second panel 34 with an exit door 36 where a cat 51 wearing a signaling device 67 is exiting the exit opening 35 by pushing on the exit door 36. FIG. 5 is a view of an assembled dome 10 from the top. Shown are the first panel, 32, an entry opening 33 and an entry door 31 in a partial closed position, a second panel 34 having an exit opening 35 with the exit door 36 over it. In front of the entry opening 33 is an entryway mat 43. Disposed over the opening in the dome 41 is a cover 40. The openings in the cover 45 form the handle 46. Shown are the alignment markings on the panels 47 and the cover 48. The location of the protrusions 50 in the cover adapted to secure the cover 40 to the dome opening 41 is illustrated by markings 47 and 48. The protrusions are shown in FIG. 2. Also shown through the openings in the cover 45 is the base 11, specifically the dome floor 19 and the bowls 30.

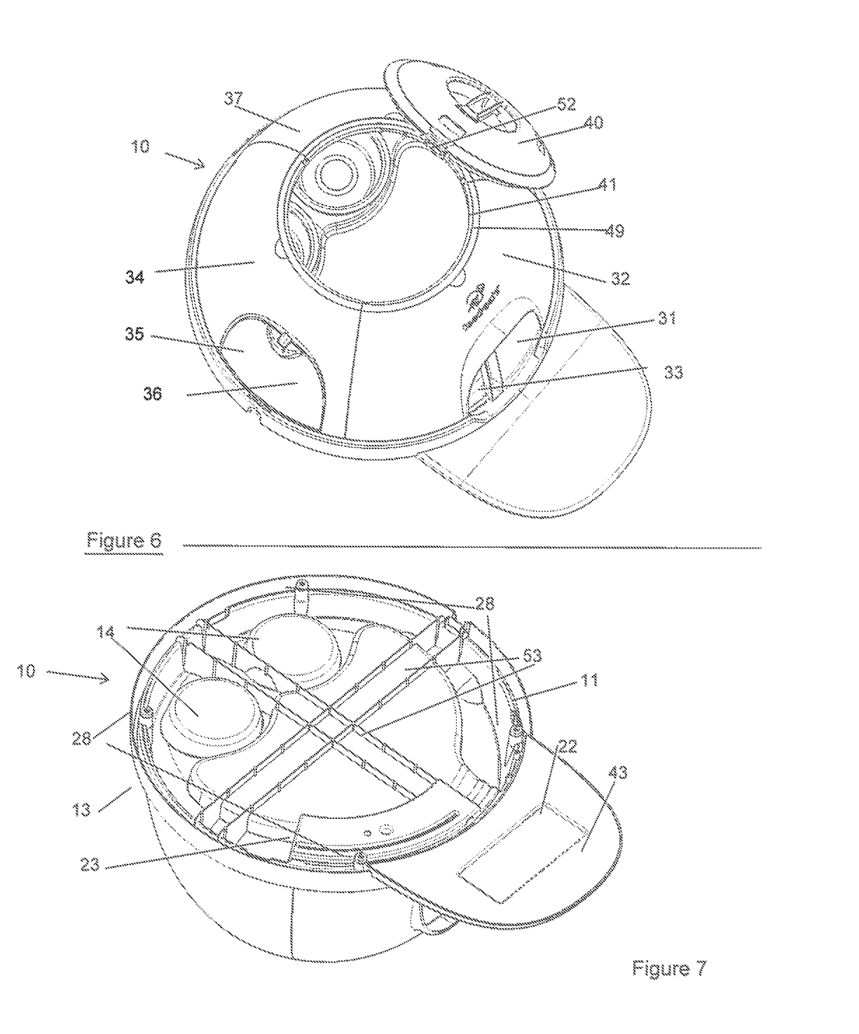

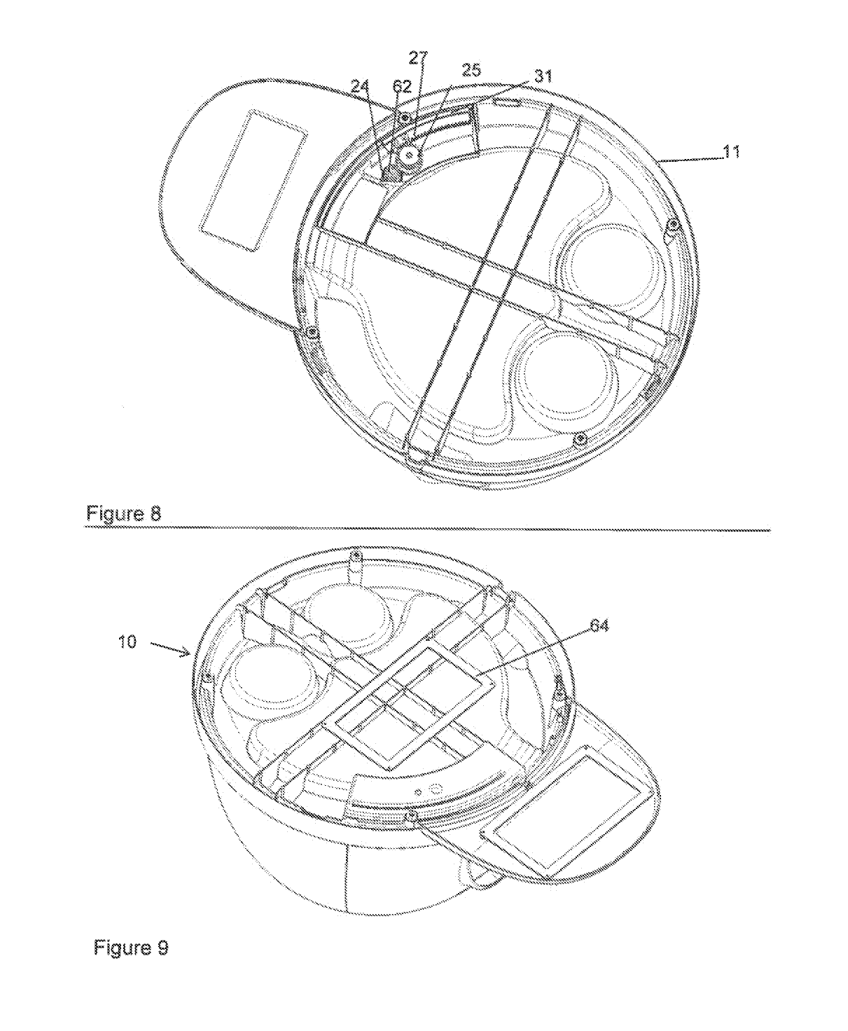

FIG. 6 shows the domed enclosure 10 from the top with the cover 40 hooked on a panel top edge 49 of the dome opening 41 using a hook 52 protruding from the bottom of the cover 40. Also shown are the entry door 31 in the entry opening 33 in the first panel 32, a second panel 34 having the exit opening 35 and exit door 36. Also shown is the third panel 37. FIG. 7 shows the assembled dome 10 from the bottom of the base 11 and the entryway mat 43. The bottom of the molded pockets 14 for the bowls is shown. The cover for the motor 23 is shown. Support ribs 53 adapted to support the base 11 are located in the base bottom. Four rubber feet 28 are spaced near the periphery of the base 13. The location of the antenna 22 in the entryway mat 43 is shown. FIG. 8 shows the bottom of the base 11 with the motor cover 23 removed to show the gear 62 on the motor 24 meshing with a clutch and drive gear 25 which meshes with the gear rack 27 attached to the bottom of the entry door 31. FIG. 9 shows the bottom of the domed enclosure 10 wherein second antenna 64 for a second sensor (not shown) which is shown in FIG. 9.

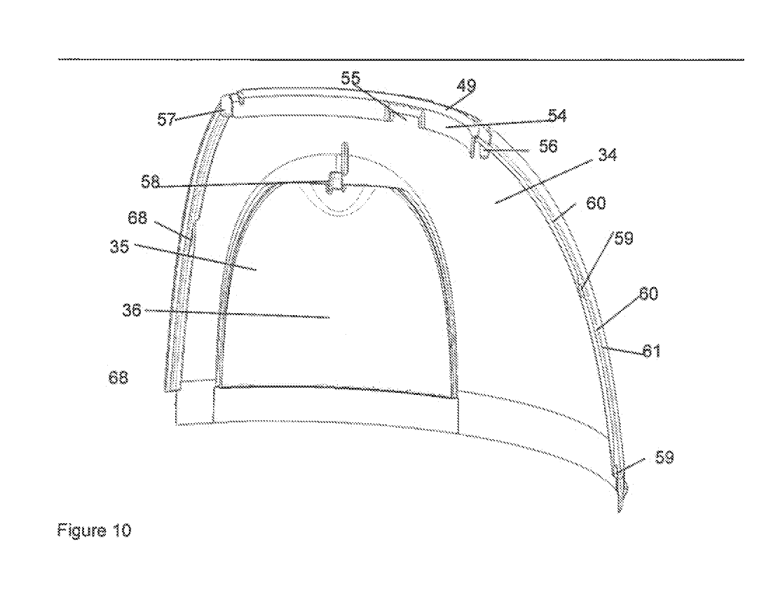

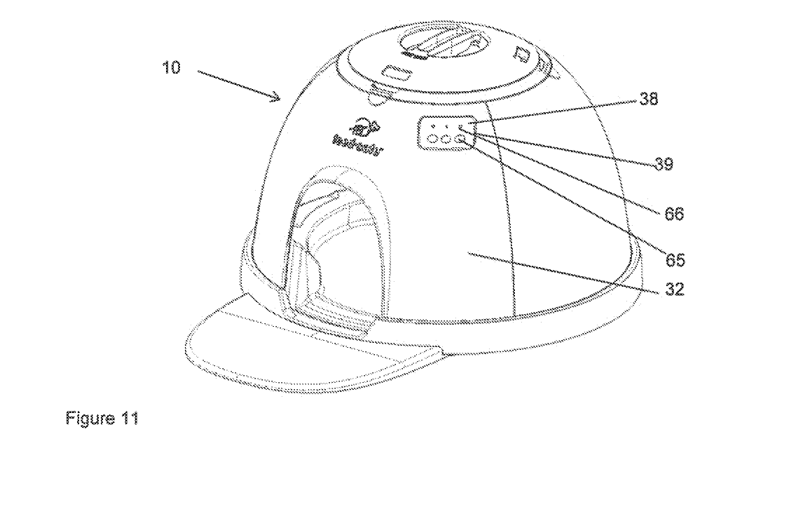

FIG. 10 shows the second panel 34 from the inside of the panel with the exit opening 35 and exit door 36. This figure shows representative features of the panels. Along the top edge of the panel 49 is a flange 54 having an inwardly offset opening in the flange 55. The opening 55 is adapted to seat the protrusions 50 of the cover 40 (not shown). Also shown is a screw boss 56 on one side of the top edge 49 of the second panel 34. On the other side of the top edge 49 of the second panel 34 is a boss pocket 57 for receiving the screw boss 56. A spring 58 connecting the top of the exit door 36 to the second panel 34 above the exit opening 35 which causes the exit door 36 to close when a pet clears the door. Shown are mid-panel and bottom panel snaps 59 and snap receiving features 68 along the panel side edges 61. Alignment guides 60, in the form of ribs and grooves, are also shown on the panel side edge 61 are present to align the panels together. The alignment guides 60 are between the top and the mid panel snap 59 and between the mid-panel snap 59 and the bottom panel snap 59. FIG. 11 shows an enclosure 10 having a control keypad 38 in an opening 39 in the first panel 32. The control keypad 38 has control buttons 65 and Indicator lights 66.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

### ELEMENT LIST

domed pet feeding structure 10
base 11
slot 12
periphery of the base 13
molded pockets 14
raised area which forms the pockets 15
ridge 16
shallow dam 17
opening in the ridge for the entry door 18
floor 19
top part of an entry mat 20
bottom part of the entry mat 21
antenna for a sensor 22
cover for the motor 23
motor 24
clutch assembly 25
programmable controller 26
gear rack 27
rubber feet 28
screws 29
bowls 30
entry door 31
a first panel 32
entry opening 33
second panel 34
exit opening 35
exit door 36
third panel 37
control keypad 38
opening for a keypad 39
cover 40
opening in the top of the dome 41
torsion spring 42
assembled entryway mat 43
panel bottom edge 44
cover openings 45
cover handle 46
markings on the panel 47
markings on the cover 48
panel top edges 49
protrusions on cover 50
cat 51
hook 52
flange 54
opening in flange 55
snap fit on top edge 56
boss to receive snap fit 57
spring on exit door 58
panel side snaps 59
alignment guides 60
panel side edges 61
gears on motor 62
transfer gear 63
control buttons 65
indicator lights 66
signaling device on pet 67
side panel snap receiving features 68

What is claimed is:

1. A kit comprising:
a) a base which forms a continuous bottom having a first side adapted to face a supporting surface and a second side facing away from the supporting surface, wherein the base forms a location to hold one or more bowls and has connection points for two or more curved panels;
b) the two or more curved panels each have a bottom edge which is adapted to be connected to the base, two side edges which are adapted to be aligned to adjacent curved panels and a top edge, wherein when the two or more curved panels are adapted to be connected to the base and to adjacent panels to form a domed structure with the top edges of the panels forming an opening at the top of the dome opposite the base;
wherein a first panel contains an opening large enough to allow a pet to pass through the opening which is adjacent to the bottom edge of the panel and the panel has a door along the inside surface of the panel which can close or partially close the opening;
a second panel contains a second opening large enough to allow a pet to pass through the opening which is adjacent to the bottom edge of the panel which is covered by one way door that is adapted to allow a pet to exit through the door by pushing on it; and
the panels in the unassembled state nest within one another and can be disposed on the base to form a relatively flat profile which can be placed in a relatively flat container for transport.

2. A kit according to claim 1 wherein the base has a slot formed about the periphery of the base which slot faces away from the supporting surface and the connection points for the curved panels are disposed in the slot in the base.

3. A kit according to claim 1 wherein the periphery of the base is a circular, elliptical or oval shape.

4. A kit according to claim 1 which further comprises a cover for the opening in the top of the dome formed when the panels are assembled to the base and together, wherein the cover can be connected to the top edges of the panels, and contains openings which form a handle in the cover by which the assembled kit can be carried.

5. A kit according to claim 1 which further comprises an entryway mat adapted to be attached to the base and disposed in front of the entry door which has a first surface adapted to face a support surface and an opposing second surface facing away from the support surface.

6. A kit according to claim 5 wherein the entryway mat contains a sensor to detect a signal from a device disposed on a pet.

7. A kit according to claim 5 which further comprises a programmable controller in electronic communication with the sensor, a drive system in electronic communication with the programmable controller and further mechanically connected to the entry door, wherein the programmable controller based on the signal sensed by the sensor can activate the drive system to move the entryway door to an open, closed or partially closed position.

8. A kit according to claim 1 wherein the cover has one or more protrusions from its bottom surface which fit into one or more inwardly offset openings in the top edge of the panels to hold it in place on the panel edge.

9. A kit according claim 1 wherein the cover has one or more hooks protruding from the bottom surface adapted to hold the cover on the edge of one of the panels when the cover is not located over the opening in the dome.

10. An article comprising:
a) a base which forms a continuous bottom having a first side adapted to face a supporting surface and a second side facing away from the supporting surface, wherein the base forms a location to hold one or more bowls and has connection points for two or more curved panels;
b) two or more curved panels each having a bottom edge which is connected to the base, two side edges which are aligned to two adjacent curved panels and a top edge, wherein when the two or more curved panels form a domed structure with the top edges of the panels forming an opening at the top of the dome opposite the base;
wherein a first curved panel contains an opening large enough to allow a pet to pass through the opening which is adjacent to the bottom edge of the panel and the panel has a door along the inside surface of the panel which can close or partially close the opening;
a second panel having a second opening large enough to allow a pet to pass through the opening which is adjacent to the bottom edge of the panel which is covered by a one way door that is adapted to allow a pet to exit through the door by pushing on it.

11. An article according to claim 10 wherein the base has a slot formed about the periphery of the base which slot faces away from the supporting surface and the connection points for the curved panels are disposed in the slot in the base.

12. An article according to claim 10 wherein the periphery of the base has a circular, elliptical or oval shape.

13. An article according to claim 10 which further comprises a cover for the opening in the top of the dome which can be connected to the top edges of the panels, contains openings in the cover and the openings form a handle in the cover by which the article can be carried.

14. An article according to claim 10 which further comprises an entryway mat attached to the base and disposed in front of the entry door which has a first surface adapted to face a support surface and an opposing second surface facing away from the support surface.

15. An article according to claim 14 wherein the entryway mat contains a sensor to detect a signal from a device disposed on a pet.

16. An article according to claim 15 which further comprises a programmable controller in electronic communication with the sensor, a drive system in electronic communication with the programmable controller and further mechanically connected to the entry door, wherein the programmable controller based on the signal sensed by the sensor can activate the drive system to move the entryway door to an open, partially closed or closed position.

17. An article according to claim 10 wherein the cover has one or more protrusions from its bottom surface which fit into one or more inwardly offset openings in the top edge of the panels to hold it in place on the panel edge.

18. An article according to claim 10 wherein the cover has one or more hooks protruding from the bottom surface adapted to hold the cover on the edge of one of the panels when the cover is not located over the opening in the dome.

19. An article according to claim 10 wherein the sensor and device on the pet are based on Radio Frequency, Infrared; magnets, image recognition, weight, and/or color recognition.

20. An article according to claim 10 wherein the top edge of the panels have a flange having an inwardly offset opening in the flange and the cover contains one or more protrusions that fit into the inwardly offset openings of the flange on the top edge of the panel such that the one or more protrusions engage the openings of the flange to hold the cover in place on the flange and the handle in the cover can be utilized to pick up the article.
